(19) United States
(12) Patent Application Publication
(10) Pub. No.: US 2015/0072152 A1
(43) Pub. Date: Mar. 12, 2015

(54) LOW VOC COATING COMPOSITION COMPRISING HIGH OLEIC OIL

(71) Applicant: AXALTA COATING SYSTEMS IP CO., LLC, Wilmington (DE)

(72) Inventors: Ayumu Yokoyama, Media, PA (US); Hari Babu Sunkara, Hockessin (DE); Rajesh Gopalan Saliya, Wilmington, PA (US); Ross Sydney Morgan, Avondale, PA (US); Kenneth A. McDiarmid, Oak Hills, CA (US)

(73) Assignee: AXALTA COATING SYSTEMS IP CO., LLC, Wilmington, DE (US)

(21) Appl. No.: 14/394,413

(22) PCT Filed: Jan. 29, 2013
(86) PCT No.: PCT/US2013/023569

§ 371 Date: Oct. 14, 2014

Related U.S. Application Data
(60) Provisional application No. 61/635,029, filed on Apr. 18, 2012.

(51) Int. Cl. C09D 175/04

(52) U.S. Cl. CPC C09D 175/04; C08K 5/09
USPC 428/423.1; 524/322; 427/385.5

(57) ABSTRACT

A coating composition comprises high oleic oil, wherein the high oleic oil comprises C18:1 fatty acids in a range of from about 60% to 100% of the fatty acid moieties in the high oleic oil and a combination of C18:2 and C18:3 fatty acids in a range of from 0% to about 10% of the fatty acid moieties in the high oleic oil, percentage based on the total fatty acid moieties in the high oleic oil. The disclosure is further directed to a coating composition comprising the high oleic oil produced from bio-resources, such as soybeans. The coating composition can have low VOC (volatile organic compounds) and can produce a coating layer having good hardness, better appearance and improved adhesion. The coating composition can be used for coating vehicles, appliances, machinery, tools, or other industrial or consumer articles.

### CROSS-REFERENCE TO RELATED APPLICATION

This application is a U.S. National-Stage entry under 35 U.S.C. §371 based on International Application No. PCT/US2013/023569, filed Jan. 29, 2013, which was published under PCT Article 21(2) and which claims priority to U.S. Provisional Application No. 61/635,029, filed Apr. 18, 2012, which are all hereby incorporated in their entirety by reference.

### TECHNICAL FIELD

The present disclosure is directed to a low VOC coating composition comprising high oleic oil. This disclosure is further directed to a low VOC coating composition comprising high oleic oil produced from bio-resources, such as soybeans.

### BACKGROUND

A typical coating finish over a substrate comprises some or all of the following layers: (1) one or more primer layers that provide adhesion and basic protection, and also cover minor surface unevenness of the substrate; (2) one or more colored layers, typically pigmented, that provide most of the protection, durability and color; and (3) one or more clearcoat layers that provide additional durability and improved appearance. A colored topcoat layer can be used in place of the colored layer and clearcoat layer.

The coating layers are formed from coating compositions that can comprise one or more volatile organic compounds (VOCs) that are compounds of carbon, which can emit into atmosphere and participate in atmospheric photochemical reactions. VOCs emitted into atmosphere, such as those emitted from coating compositions during coating manufacturing, application and curing process, can be related to air pollution impacting air quality, participate in photoreactions with air to form ozone, and contribute to urban smog and global warming.

Efforts have been made to reduce VOC emissions into the air. For example, the coating industry has been trying to develop low VOC coating compositions. VOC exempt organic compounds can also be used to substitute or replace part or all VOCs in some industrial applications, such as coatings. The VOC exempt organic compounds are compounds of carbon and are believed not to participate in atmospheric photochemical reactions to form smog. Examples of VOC exempt compounds can include acetone, methyl acetate, and PCBTF (Oxsol 100). However, production of low VOC products or converting naturally occurring volatile organic compounds into VOC exempt organic compounds can require the consumption of additional materials and energy, which may in turn cause further increase in net output of other materials such as carbon dioxide that has been attributed to global warming.

Therefore, it is desirable to provide coating compositions that have low VOCs. In addition, other objects, desirable features and characteristics will become apparent from the subsequent summary and detailed description, and the appended claims, taken in conjunction with the accompanying drawings and this background.

### SUMMARY

According to an exemplary embodiment, a coating composition comprises:

a film forming polymer chosen from acrylic polymers, polyester polymers, polyurethane polymers, latex polymers, and a combination thereof; and

a high oleic oil mixed in the film forming polymer, wherein the high oleic oil comprises C18:1 fatty acids in a range of from about 60% to 100% of the fatty acid moieties in the oil and a combination of C18:2 and C18:3 fatty acids in a range of from 0% to about 10% of the fatty acid moieties in the oil, percentage based on the total fatty acid moieties in the high oleic oil, and the high oleic oil has an oxidative stability index in a range of from about 50 hours to about 100 hours at 110° C. measured in the absence of antioxidant.

A further exemplary embodiment is directed to a process for forming a dry coating layer over a substrate, the process comprising the steps of:

forming a coating composition comprising a high oleic oil and a film forming polymer chosen from acrylic polymers, polyester polymers, polyurethane polymers, latex polymers, and a combination thereof, wherein the high oleic oil comprises C18:1 fatty acids in a range of from about 60% to about 100% of the fatty acid moieties in the high oleic oil and a combination of C18:2 and C18:3 fatty acids in a range of from 0% to about 10% of the fatty acid moieties in the high oleic oil, percentage based on the total fatty acid moieties in the high oleic oil, and the high oleic oil has an oxidative stability index in a range of from about 50 hours to about 100 hours at 110° C. measured in the absence of antioxidant; and

applying the coating composition over the substrate to form a wet coating layer thereon.

Another exemplary embodiment is directed to a coated article comprising a substrate coated with one or more coating layers thereon, wherein at least one of the coating layers is formed from the coating composition of this disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

The disclosures of all patent and non-patent literature cited herein are incorporated herein by reference in their entirety.

As used herein:

“Gloss” means surface gloss of a coating surface and is related to the amount of incident light that is reflected at the specular reflectance angle of the mean of that surface. Gloss can be measured with a specular glossmeter, such as those available from Byk-Gardener, Geretsried, Germany.

The term “volatile organic compound”, “VOC”, “volatile organic compounds”, or “VOCs” refers to organic chemical compounds of carbon that can vaporize and enter the atmosphere and participate in atmospheric photochemical reactions. VOCs can be naturally occurring or produced from natural or synthetic materials. Some or all VOCs can be regulated under local, national, regional, or international authorities. VOC can be expressed as weight of VOC on a unit of volume of a product, such as pounds per gallon (lbs/gal). Amounts of VOC in a coating composition can be determined according to ASTM D3960.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (about 15 minutes to about 45 minutes) to a few hours (about 4 hours to about 8 hours). The pot mix is then applied as a layer of a desired thickness on a substrate surface, such as an automobile body. After application, the layer dries and cures at ambient or at elevated temperatures to form a coating on the substrate surface having desired coating properties, such as, adhesion, high gloss, and high DOI.

A pot life is a time period between the time when components of a coating composition are mixed to form a pot mix, referred to as time zero, and to the time when the pot mix becomes too thick or too hard for practical application. A pot life of a specific coating composition is a characteristic of that coating composition and is typically determined empirically. Pot life can be measured, for example, by the length of time required to double viscosity of the coating composition or pot mix using Zahn cup viscosity measurements. If after 24 hours, viscosity of a coating composition is not doubled, said coating composition can be referred to as having indefinite pot life.

The term “one-pack coating composition” or “1K coating composition” refers to a coating composition having one package that can be stored for a certain shelf life. For example, a 1K coating composition can be a UV mono-cure coating composition that can be prepared to form a pot mix and stored in a sealed container. As long as the UV mono-cure coating composition is not exposed to UV radiation, the UV mono-cure coating composition can have indefinite pot life. Other examples of 1K coating compositions can include 1K coating compositions having a blocked crosslinking agent such as a blocked isocyanate, a moisture curing 1K coating composition, an oxygen curing 1K coating composition, or a heat curing 1K coating composition as known in coating industry.

The term “crosslinkable component” refers to a component having “crosslinkable functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film-forming crosslinked structures. The crosslinking component can comprise one or more crosslinking agents that have the crosslinking functional groups.

Typical crosslinking functional groups can include hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide or a workable combination thereof.

It would be clear to one of ordinary skill in the art that certain crosslinking functional groups crosslink with certain crosslinkable functional groups. Examples of paired combinations of crosslinkable and crosslinking functional groups include: (1) amine and protected amine such as ketimine and aldimine functional groups generally crosslink with acetoacetoxy, epoxy, or anhydride functional groups; (2) isocyanate, thioisocyanate and melamine functional groups generally crosslink with hydroxyl, thiol, primary and secondary amine, ketimine, or aldimine functional groups; (3) epoxy functional groups generally crosslink with carboxyl, primary and secondary amine, ketimine, aldimine or anhydride functional groups; and (4) carboxyl functional groups generally crosslink with epoxy or isocyanate functional groups.

The term “volatile organic compound”, “VOC”, “volatile organic compounds”, or “VOCs” refers to organic chemical compounds of carbon that can vaporize and enter the atmosphere and participate in atmospheric photochemical reactions. VOCs can be naturally occurring or produced from natural or synthetic materials. Some or all VOCs can be regulated under local, national, regional, or international authorities. VOC can be expressed as weight of VOC on a unit of volume of a product, such as pounds per gallon (lbs/gal). Amounts of VOC in a coating composition can be determined according to ASTM D3960.

This disclosure is directed to a coating composition. The coating composition can comprise:

a film forming polymer selected from acrylic polymers, polyester polymers, polyurethane polymers, latex polymers, and a combination thereof; and

a high oleic oil mixed in the film forming polymers, wherein the high oleic oil comprises C18:1 fatty acids in a range of from about 60% to about 100% of the fatty acid moieties in the oil and a combination of C18:2 and C18:3 fatty acids in a range of from 0% to about 10% of the fatty acid moieties in the oil, percentage based on the total fatty acid moieties in the high oleic oil, and the high oleic oil has an oxidative stability index in a range of from about 50 hours to about 100 hours at 110° C. measured in the absence of antioxidant.

The high oleic oil can comprise C18:1 fatty acids in a range of from about 60% to about 100% in one example, about 70% to about 100% in another example, about 75% to about 100% in yet another example, about 80% to about 100% in yet another example, of the fatty acid moieties in the oil, percentage based on the total fatty acid moieties in the high oleic oil.

The film forming polymer can comprise a crosslinkable functional group. The crosslinkable functional group can be selected from a hydroxyl group, an epoxy group, an amine group, a urethane groups, or a combination thereof.

The coating composition can further comprise:

a crosslinking component comprising a crosslinking functional group that reacts with the crosslinkable functional group to form a crosslinked structure.

The crosslinking functional group can be selected from a isocyanate group, a melamine group, or a combination thereof.

The aforementioned coating composition can further comprise an alkyd cobalt catalyst, a tin catalyst, or a combination thereof. In one example, the coating composition can comprise the aforementioned crosslinking component comprising a crosslinking functional group selected from an isocyanate group, a melamine group, or a combination thereof, a tin catalyst and an alkyd cobalt catalyst. Commercial tin catalyst such as G-805™ available under respective registered trademark or trademark from E. I. DuPont de Nemours and Company, Wilmington, Del., USA, and commercial alkyd catalyst such as Cobalt TEN-CEM® under registered trademark available from OM Group, Inc., Cleveland, Ohio, USA, can be suitable.

The high oleic oil can comprise C18:1 fatty acids (fatty acids having 18 carbon and 1 unsaturated double bond, also known as monounsaturated C18 fatty acids) in a range of from about 80% to 100% of the fatty acid moieties in the high oleic oil and a combination of C18:2 (fatty acids having 18 carbon and 2 double bonds) and C18:3 fatty acids (fatty acids having 18 carbon and 3 double bonds) in a range of from 0% to about 8% of the fatty acid moieties in the high oleic oil, percentage based on the total fatty acid moieties in the high oleic oil. The C18:1 fatty acids can be in cis-isoform. In one example, the high oleic oil can have in a range of from about 80% to 100% of the C18:1 fatty acids in cis-isoform, percentage based on the total weight of the C18:1 fatty acids in the high oleic oil. In another example, the high oleic oil can have in a range of from about 80% to 100% of all fatty acids in cis-isofrom, percentage based on the total weight of the fatty acids in the high oleic oil.

The high oleic oil can comprise high oleic oil produced form a genetically modified soybean.

In one example, the high oleic oil can be produced by recombinant manipulation of the activity of oleoyl 12-desaturase. In soy (Glycine max) there are two genes for this activity, one of which (GmFad 2-1) is expressed only in the developing seed (Heppard et al. (1996) Plant Physiol. 110:311-319). The other gene (GmFad 2-2) is expressed in the seed, leaf, root and stem of the soy plant at a constant level and is the “housekeeping” 12-desaturase gene. The GmFad 2-2 gene product is responsible for the synthesis of polyunsaturated fatty acids for cell membranes. The GmFad 2-1 can be placed under the control of a strong, seed-specific promoter derived from the α′-subunit of the soybean (Glycine max) β-conglycinin gene. The GmFad 2-1 open reading frame (ORF) are placed in a sense orientation with respect to the promoter so as to produce a gene silencing of the sense GmFad 2-1 cDNA and the endogenous GmFad 2-1 gene, therefore turning off oleoyl 12-desaturase gene expression in the genetically modified soybean. The GmFad 2-1 construct can become integrated at two different loci in the soybean genome as described in U.S. Pat. No. 5,981,781, hereby incorporated in by reference. The genetically modified soybean can produce a relative oleic acid content of about 85% (compared with about 20% in elite soybean varieties). The high oleic oil can be extracted and purified as described in the aforementioned US patent. Commercial products, such as Plenish™ 8B High Oleic Soybean Oil, available under respective registered trademark or trademark from Pioneer® Hi-Bred, Johnston, Iowa 50131, USA, can be suitable.

The high oleic oil produced form a genetically modified soybean can have high oxidative stability. A number of methods are well known to those skilled in the art for determining oxidative stability. The most commonly used method is the Active Oxygen Method (AOM). This is an accelerated oxidation test in which an oil is aerated under a constant, elevated temperature, such as 97.8° C., and degradation is monitored by measuring peroxide accumulation. The end point, or induction time, is determined by the number of hours required to reach a peroxide value of 100 meq/kg (milliequivalents peroxide per kg) of oil tested. Thus, the longer the induction time the more stable the oil. Typically, almost all commercial oil samples specify an AOM induction time as a component of the technical data sheet.

The AOM induction time for the high oleic soybean oil suitable for this disclosure can be in a range of from about 50 to about 140 hours in one example, about 75 to about 140 hours in another example, and about 100 to about 140 hours in yet another example.

Another standard method now commonly used to evaluate the stability of commercial cooking oils is the Oxidative Stability Index (OSI) which can be measured automatically using an OSI machine, such as the one available from Ominion, Inc. of Rockland, Mass., USA. Other OSI machines can also be suitable. The OSI machine can work by bubbling air through oil heated to 110° C. As the oil oxidizes, volatile organic acids, primarily formic acid, is formed which can be collected in distilled water in a cell. The machine constantly measures the conductivity of the distilled water and the induction period is determined as the time it takes for this conductivity to begin a rapid rise.

Although the data derived from the two methods do not always have a straight correlation, the OSI induction time values for most oils are generally about half those of the AOM derived values.

The OSI induction time value for the high oleic soybean oil suitable for this disclosure can be in a range of from about 25 to about 100 hours in one example, about 50 to about 100 hours in another example, and about 75 to about 100 hours in yet another example.

In some cases, antioxidants may be added to improve stability but not all antioxidants withstand high temperatures. For the high oleic oil suitable for this disclosure, oxidative stability index can be measured in the absence of antioxidant.

The total VOC (volatile organic compounds) of the coating composition can be in a range of from about 0.5 lb/gal to about 1.9 lb/gal (pounds of VOCs per gallon of the coating composition).

The coating composition can further comprise one or more pigments, wetting agents, leveling and flow control agents, leveling agents based on (meth)acrylic homopolymers, rheological control agents, thickeners, antifoaming agents, catalysts, one or more organic solvents, or a combination thereof. The coating composition can also comprise other oils, such as other oils having C16-C20 fatty acids, other oils have one or more unsaturated double bonds, or a combination thereof.

The film forming polymers can comprise linear polymers, branched polymers, or a combination thereof.

The coating composition can be a primer coating composition, a basecoat coating composition, or a top coat coating composition. The coating composition can comprise in a range of from about 1% to about 40% of the high oleic oil, percent based on the total weight of the coating composition.

The coating composition can be a waterborne or a solvent borne coating composition. A solvent borne coating composition can comprise in a range of from 0% to about 20% of water. A waterborne coating composition can comprise in a range of from about 20% to about 80% water. When the coating composition comprises in a range of from about 20% to about 80% of water, the coating composition can further comprise one or more surfactants, emulsifiers, or a combination thereof, percent based on the total weight of the coating composition.

A coating layer formed from the coating composition disclosed herein can have a Persoz hardness at least about 50 sec in one example, at least about 55 sec in another example. The hardness can be measured after the coating is cured for a few hours. In one example, the hardness can be measured after the coating has been cured for a few hours. In another example, the hardness can be measured after the coating has been cured for 24 hours at ambient temperature, such as in a range of from about 15° C. to about 35° C. Generally, the hardness can be a maximum hardness measured after the coating has been cured for in a range of from about 5 to about 48 hours.

This disclosure is further directed to a coated article comprising a substrate coated with one or more coating layers thereon, wherein at least one of the coating layers is formed from the coating composition of this disclosure. The substrate can be a vehicle, a vehicle part, or a combination thereof.

This disclosure is further directed to a process for forming a dry coating layer over a substrate. The process comprising the steps of:

forming a coating composition comprising a high oleic oil and a film forming polymer chosen from acrylic polymers, polyester polymers, polyurethane polymers, latex polymers, and a combination thereof, wherein the high oleic oil comprises C18:1 fatty acids in a range of from about 75% to about 100% of the fatty acid moieties in the high oleic oil and a combination of C18:2 and C18:3 fatty acids in a range of from 0% to about 10% of the fatty acid moieties in the high oleic oil, percentage based on the total fatty acid moieties in the high oleic oil, and the high oleic oil has an oxidative stability index in a range of from about 50 hours to about 100 hours at 110° C. measured in the absence of antioxidant; and

applying the coating composition over the substrate to form a wet coating layer thereon.

The process can further comprise the step of:

curing the wet coating layer at an ambient temperature in a range of from about 15° C. to about 35° C., at an elevated temperature in a range of from about 35° C. to about 200° C., or a combination thereof, to form the dry coating layer.

The high oleic oil can comprise C18:1 fatty acids in a range of from about 80% to 100% of the fatty acid moieties in the high oleic oil and a combination of C18:2 and C18:3 fatty acids in a range of from 0% to about 8% of the fatty acid moieties in the high oleic oil, percentage based on the total fatty acid moieties in the high oleic oil. The high oleic oil can comprise aforementioned high oleic oil produced form a genetically modified soybean.

The film forming polymer can be chosen from acrylic polymers, polyester polymers, polyurethane polymers, latex polymers, and a combination thereof. Typical polymers suitable for coating compositions can be suitable.

The acrylic polymers can have a weight average molecular weight (Mw) of about 1,500 to about 100,000, and contain crosslinking functional groups, such as, for example, hydroxyl, amino, amide, glycidyl, silane and carboxyl groups. The acrylic polymers can be linear polymers, branched polymers, or other polymers. The acrylic polymers can be polymerized from a plurality of monomers, such as acrylates, methacrylates or derivatives thereof. Suitable monomers can include linear alkyl (meth)acrylates having 1 to 12 carbon atoms in the alkyl group, cyclic or branched alkyl (meth)acrylates having 3 to 12 carbon atoms in the alkyl group. Suitable monomers can also include, for example, hydroxyalkyl esters of alpha,beta-olefinically unsaturated monocarboxylic acids with primary or secondary hydroxyl groups. These may, for example, comprise the hydroxyalkyl esters of acrylic acid, methacrylic acid, crotonic acid and/or isocrotonic acid. Suitable monomers can also include monomers that are reaction products of alpha,beta-unsaturated monocarboxylic acids with glycidyl esters of saturated monocarboxylic acids branched in alpha position, for example with glycidyl esters of saturated alpha-alkylalkanemonocarboxylic acids or alpha,alpha'-dialkylalkanemonocarboxylic acids. These can comprise the reaction products of (meth)acrylic acid with glycidyl esters of saturated alpha,alpha-dialkylalkanemonocarboxylic acids with 7 to 13 carbon atoms per molecule, particularly preferably with 9 to 11 carbon atoms per molecule. These reaction products can be formed before, during or after copolymerization reaction of the acrylic polymer. Suitable monomers can further include monomers that are reaction products of hydroxyalkyl (meth)acrylates with lactones. Hydroxyalkyl (meth)acrylates which can be used include, for example, those stated above. Suitable lactones can include, for example, those that have 3 to 9 carbon atoms in the ring, wherein the rings can also comprise different substituents. The hydroxyl groups of the hydroxyalkyl esters can be modified with the lactone before, during or after the copolymerization reaction. Suitable monomers can also include unsaturated monomers such as, for example, allyl glycidyl ether, 3,4-epoxy-1-vinylcyclohexane, epoxycyclohexyl (meth)acrylate, vinyl glycidyl ether and glycidyl (meth)acrylate, that can be used to provide the acrylic polymer with glycidyl groups. In one example, glycidyl (meth)acrylate can be used. Suitable monomers can also include monomers that are free-radically polymerizable, olefinically unsaturated monomers which, apart from at least one olefinic double bond, do not contain additional functional groups. Such monomers include, for example, esters of olefinically unsaturated carboxylic acids with aliphatic monohydric branched or unbranched as well as cyclic alcohols with 1 to 20 carbon atoms. Suitable monomers can also include unsaturated monomers that do not contain additional functional groups for example, vinyl ethers, such as, isobutyl vinyl ether and vinyl esters, such as, vinyl acetate, vinyl propionate, vinyl aromatic hydrocarbons, preferably those with 8 to 9 carbon atoms per molecule. Examples of such monomers can include styrene, alpha-methylstyrene, chlorostyrenes, 2,5-dimethylstyrene, p-methoxystyrene, vinyl toluene. In one embodiment, styrene can be used. Suitable monomers can also include small proportions of olefinically polyunsaturated monomers. These olefinically polyunsaturated monomers are monomers having at least 2 free-radically polymerizable double bonds per molecule. Examples of these olefinically polyunsaturated monomers can include divinylbenzene, 1,4-butanediol diacrylate, 1,6-hexanediol diacrylate, neopentyl glycol dimethacrylate, and glycerol dimethacrylate.

The acrylic polymers of this disclosure can generally be polymerized by free-radical copolymerization using conventional processes well known to those skilled in the art, for example, bulk, solution or bead polymerization, in particular by free-radical solution polymerization using free-radical initiators.

The acrylic polymer can contain (meth)acrylamides. Typical examples of such acrylic polymers can be polymerized from monomers including (meth)acrylamide. In one example, such acrylic polymer can be polymerized from (meth)acrylamide and alkyl (meth)acrylates, hydroxy alkyl (meth)acrylates, (meth)acrylic acid and one of the aforementioned olefinically unsaturated monomers.

The acrylic polymers can have one or more crosslinkable functional groups. At least one of the one or more crosslinkable functional groups can be a hydroxyl group.

The polyester polymers can be linear polyesters or copolyesters, branched polyesters or copolyesters, highly branched polyesters or copolyesters, or a combination thereof. The highly branched copolyester can have a hydroxyl number in a range of from about 5 to about 200 and can have a weight average molecular weight in a range of from about 1,000 to about 50,000.

The polyester polymers can have one or more crosslinkable functional groups. At least one of the one or more crosslinkable functional groups can be a hydroxyl group.

Polyurethane polymers can be suitable for the coating composition of this disclosure. Examples of polyurethane polymers can include acrylourethanes. Typical useful acrylourethanes can be formed by reacting the aforementioned acrylic polymers with an organic polyisocyanate. Generally, an excess of the acrylic polymer is used so that the resulting acrylourethane can have terminal acrylic segments having reactive groups such as crosslinkable functional groups such as hydroxyl, carboxyl, amine, glycidyl, amide, silane, or acombination thereof. At least one of the one or more crosslinkable functional groups can be a hydroxyl group.

The latex polymers can be any latex polymers that are suitable for coatings.

The film forming polymers can alkyd resins that can include esterification products. Examples of esterification products can include a drying oil fatty acid, such as linseed oil and tall oil fatty acid, dehydrated castor oil, a polyhydric alcohol, a dicarboxylic acid and an aromatic monocarboxylic acid.

The coating composition can further comprise one or more pigments, one or more solvents, conventional coating additives, ultraviolet light stabilizers, ultraviolet light absorbers, antioxidants, hindered amine light stabilizers, leveling agents, rheological agents, thickeners, antifoaming agents, wetting agents, catalysts, or a combination thereof. Examples of additives can include wetting agents, leveling and flow control agents, for example, Resiflow®S (polybutylacrylate), BYK® 320 and 325 (high molecular weight polyacrylates), BYK® 347 (polyether-modified siloxane) under respective registered tradmarks, leveling agents based on (meth)acrylic homopolymers; rheological control agents, such as highly disperse silica, fumed silica or polymeric urea compounds; thickeners, such as partially crosslinked polycarboxylic acid or polyurethanes; antifoaming agents; catalysts for the crosslinking reaction of the OH-functional binders, for example, organic metal salts, such as, dibutyltin dilaurate, zinc naphthenate and compounds containing tertiary amino groups, such as, triethylamine, for the crosslinking reaction with polyisocyanates. The additives are used in conventional amounts familiar to those skilled in the art.

The crosslinking component can further comprise one or more polyisocyanates each having two or more free isocyanate functional groups that react with the crosslinkable functional groups in the crosslinkable component when present. The polyisocyanates can be mixed with the crosslinking activator in the crosslinking component after the SCA is formed in the presence of the alkylated melamines. Alternatively, the crosslinking activator having the SCA formed in the presence of the alkylated melamines can be added into the crosslinking component that contains the polyisocyanates. Examples of polyisocyanates can include aliphatic polyisocyanates, cycloaliphatic polyisocyanates, aromatic polyisocyanates and isocyanate adducts. Examples of suitable aliphatic, cycloaliphatic and aromatic polyisocyanates that can include: 2,4-toluene diisocyanate, 2,6-toluene diisocyanate (“TDI”), 4,4-diphenylmethane diisocyanate (“MDI”), 4,4′-dicyclohexyl methane diisocyanate (“H12MDI”), 3,3′-dimethyl-4,4′-biphenyl diisocyanate (“TODI”), 1,4-benzene diisocyanate, trans-cyclohexane-1,4-diisocyanate, 1,5-naphthalene diisocyanate (“NDI”), 1,6-hexamethylene diisocyanate (“HDI”), 4,6-xylene diisocyanate, isophorone diisocyanate, (“IPDI”), other aliphatic or cycloaliphatic di-, tri- or tetra-isocyanates, such as, 1,2-propylene diisocyanate, tetramethylene diisocyanate, 2,3-butylene diisocyanate, octamethylene diisocyanate, 2,2,4-trimethyl hexamethylene diisocyanate, dodecamethylene diisocyanate, omega-dipropyl ether diisocyanate, 1,3-cyclopentane diisocyanate, 1,2-cyclohexane diisocyanate, 1,4-cyclohexane diisocyanate, 4-methyl-1,3-diisocyanatocyclohexane, dicyclohexylmethane-4,4′-diisocyanate, 3,3′-dimethyl-dicyclohexylmethane 4,4′-diisocyanate, polyisocyanates having isocyanurate structural units, such as, the isocyanurate of hexamethylene diisocyanate and the isocyanurate of isophorone diisocyanate, the adduct of 2 molecules of a diisocyanate, such as, hexamethylene diisocyanate, uretidiones of hexamethylene diisocyanate, uretidiones of isophorone diisocyanate and a diol, such as, ethylene glycol, the adduct of 3 molecules of hexamethylene diisocyanate and 1 molecule of water, allophanates, trimers and biurets, for example, of hexamethylene diisocyanate, allophanates, trimers and biurets, for example, of isophorone diisocyanate and the isocyanurate of hexane diisocyanate. MDI, HDI, TDI and isophorone diisocyanate are preferred because of their commercial availability.

Tri-functional isocyanates also can be used, such as, triphenyl methane triisocyanate, 1,3,5-benzene triisocyanate, 2,4,6-toluene triisocyanate. Trimers of diisocyanates, such as, the trimer of hexamethylene diisocyanate, sold as Tolonate® HDT from Rhodia Corporation and the trimer of isophorone diisocyanate are also suitable.

An isocyanate functional adduct can be used, such as, an adduct of an aliphatic polyisocyanate and a polyol or an adduct of an aliphatic polyisocyanate and an amine. Also, any of the aforementioned polyisocyanates can be used with a polyol to form an adduct. Polyols, such as, trimethylol alkanes, particularly, trimethylol propane or ethane can be used to form an adduct.

Due the presence of the crosslinking component that can comprise one or more polyisocyanates, the coating composition is typically not suitable for use as food or a part of food.

Depending upon the type of crosslinking agent, the coating composition contemplated herein can be formulated as one-pack (1K) or two-pack (2K) coating composition. If polyisocyanates with free isocyanate groups are used as the crosslinking agent, the coating composition can be formulated as a two-pack coating composition in that the crosslinking agent is mixed with other components of the coating composition only shortly before mixing with the matting agent of this invention. If blocked polyisocyanates are, for example, used as the crosslinking agent, the coating compositions can be formulated as a one-pack (1K) coating composition.

The coating composition can comprise up to about 80% by weight, based on the weight of the coating composition, of one or more solvents. Typically, the coating composition can have a solid content in a range of from about 20% to about 80% by weight in one example, in a range of from about 50% to about 80% by weight in another example and in a range of from about 60% to about 80% by weight in yet another example, all based on the total weight of the coating composition.

The coating composition can comprise one or more organic solvents. Typical organic solvents suitable for coatings can be used to form the coating composition contemplated herein. Examples of solvents can include, but not limited to, aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate, and a combination thereof. In one example, the coating composition can comprise one or more solvents selected from aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate; or a combination thereof, percent based on the total weight of the coating composition, and wherein the total VOC (volatile organic compounds) of the coating composition can be in a range of from about 0.5 lb/gal to about 1.9 lb/gal (pounds of VOCs per gallon of the coating composition).

The coating composition contemplated herein can be formulated as a clearcoat or pigmented coating composition. The coating composition can be used as a primer, a basecoat, topcoat, such as colored topcoat. Conventional inorganic and organic colored pigments, metallic flakes and powders, such as, aluminum flake and aluminum powders; special effects pigments, such as, coated mica flakes, coated aluminum flakes colored pigments, or a combination thereof can be used. Transparent pigments or pigments having the same refractive index as the cured binder can also be used. One example of such transparent pigment can be silica.

The coating composition can be a one-pack (1K) or two-pack (2K) coating composition. In a typical two-pack coating composition comprising two packages, the two packages are mixed together shortly before application. The first package typically can contain the crosslinkable component. Optionally, one or more pigments can be dispersed in the first package using conventional dispersing techniques, for example, ball milling, sand milling, and attritor grinding. The first package can also comprise one or more solvents. The second package can contain the crosslinking component, and optionally, one or more solvents. When present, the catalysts and other additives can be added in either the first or the second package prior to mixing. Alternatively, the catalysts and other additives can be added immediately after the first and the second packages are mixed together and before the coating composition is applied to a substrate or cured. The high oleic oil can be added to the first package, the second package, or a combination thereof.

The substrate can be any articles or objects that can be coated with a coating composition. The substrate can be a vehicle or parts of a vehicle. The coating composition according to the disclosure can be suitable for vehicle and industrial coating and can be applied using known processes. In the context of vehicle coating, the coating composition can be used both for vehicle original equipment manufacturing (OEM) coating and for repairing or refinishing coatings of vehicles and vehicle parts. Curing of the coating composition can be accomplished at ambient temperatures, such as temperatures in a range of from about 15° C. to about 35° C., or at elevated temperatures, such as at temperatures in a range of from about 35° C. to about 150° C. Typical curing temperatures of about 15° C. to about 80° C., in particular of about 15° C. to about 60° C., can be used for vehicle repair or refinish coatings.

The high oleic oil produced from soybeans is known to be suitable for food uses, and can be stable and remain in oil form without drying in food over longer periods of time due to its high oxidation stability, such as described in the aforementioned U.S. Pat. No. 5,981,781.

Applicants unexpectedly discovered that when the high oleic oil is adding into a coating composition, the coating composition can have improved hardness, higher gloss, faster dry, and better adhesion.

### Testing Procedures

Dry Film Thickness—test method ASTM D4138

Viscosity—can be measured using (1) Zahn Viscosity as determined using a #1 Zahn cup according to ASTM D 1084 Method D; (2) Gardner-Holdt Letter scale according to ASTM D1545; or (3) Brookfield viscometer; as specified.

Persoz Hardness Test—the change in film hardness of the coating was measured with respect to time, in second, after application by using a Persoz Hardness Tester Model No. 5854 [ASTM D4366] supplied by Byk-Mallinckrodt, Wallingford, Conn.

Molecular weights Mw and Mn and the polydispersity (Mw/Mn) of the acrylic polymer and other polymers are determined by GPC (Gel Permeation Chromatography) using polystyrene standards and tetrahydrofuran as the solvent.

Dry to touch time—Dry to touch time is determined by ASTM D1640.

Tack Free Time—Tack free time was determined with Mechanical Test Method according to ASTM D 1640-95. The mechanical test method was originally described in U.S. Pat. No. 2,406,989.

DOI—Instrumental measurement of distinctness of Image (DOI) gloss of coating surfaces is determined according to ASTM D 5767.

Gloss—measured with standard test method for specular gloss according to ASTM D 523.

In the following examples, all parts and percentages are on a weight basis unless otherwise indicated. “Mw” weight average molecular weight and “Mn” means number average molecular weight.

### EXAMPLES

The present invention is further defined in the following Examples. It should be understood that these Examples, while indicating preferred embodiments, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Coating Compositions

Coating compositions were prepared according to Table 1, Table 2 and Table 3.

TABLE 1
Coating Compositions (in weight grams).

| | Comp Exp. 1 | Comp Exp. 2 | Exp. 1 |
|---|---|---|---|
| White Color Coat 9P01 ™ ⁽¹⁾ | 320 | 320 | 320 |
| Urethane Activator 9T00-A ™ ⁽¹⁾ | 40 | 40 | 40 |
| Catalyst Solution VG-805 ™ ⁽¹⁾ | 5 | 5 | 5 |
| Linseed Oil ⁽²⁾ | 40 | 0 | 0 |
| Soybean Oil ⁽³⁾ | 0 | 0 | 40 |
| n-butyl acetate ⁽⁴⁾ | 0 | 40 | 0 |

⁽¹⁾ Available under respective registered trademark or trademark from E. I. DuPont de Nemours and Company, Wilmington, DE, USA.
⁽²⁾ Linseed oil #QL045 available from W.M. Barr & Co, Memphis, TN 38113, USA.
⁽³⁾ Plenish ™ 8B High Oleic Soybean Oil Lot #189086, available under respective registered trademark or trademark from Pioneer ® Hi-Bred, Johnston, IA 50131, USA.
⁽⁴⁾ Available from Dow Chemical, 2030 Dow Center, Midland, Michigan 48674, USA.

TABLE 2
Coating Compositions (in weight grams).

| | Comp | Comp | | | |
|---|---|---|---|---|---|
| | Exp. 3 | Exp. 4 | Exp. 2 | Exp. 3 | Exp. 4 |
| White Color Coat | 400 | 400 | 400 | 400 | 400 |
| 9P01 ™ ⁽¹⁾ | | | | | |
| Urethane Activator | 100 | 100 | 100 | 100 | 100 |
| 9T00-ATM ⁽¹⁾ | | | | | |
| Catalyst Solution VG- | 0 | 0 | 0 | 3 | 3 |
| 805 ™ ⁽¹⁾ | | | | | |
| Alkyds catalyst ⁽⁵⁾ | 0 | 3 | 3 | 0 | 3 |
| Linseed Oil ⁽²⁾ | 0 | 40 | 0 | 0 | 0 |
| Soybean Oil ⁽³⁾ | 0 | 0 | 40 | 40 | 40 |
| n-butyl acetate ⁽⁴⁾ | 40 | 0 | 0 | 0 | 0 |

⁽¹⁾-⁽⁴⁾ same as that in Table 1.
⁽⁵⁾ The alkyd catalyst used herein was Cobalt TEN-CEM ® under registered trademark available from OM Group, Inc., Cleveland, Ohio, USA.

TABLE 3
One-Pack (1K) Coating Compositions (in weight grams).

| | Comp | Comp | |
|---|---|---|---|
| | Exp. 5 | Exp. 6 | Exp. 5 |
| Imron ® 1.2 HG ™ ⁽¹⁾ | 320 | 320 | 320 |
| Linseed Oil ⁽²⁾ | 40 | 0 | 0 |
| Soybean Oil ⁽³⁾ | 0 | 0 | 40 |
| Butyl Glycol ⁽⁶⁾ | 0 | 40 | 0 |

⁽¹⁾-⁽³⁾ same as that in Table 1.
⁽⁶⁾ Available from Dow Chemical, Midland, Michigan, USA.

### Coating Properties

The coating compositions were applied on E/C steel test panel ACT CRS Powercron 590, available from ACT Test Panels LLC, Hillsdale, Mich. 49242, using wet draw down at about 4 mil (equivalent to about 0.102 mm) wet coating thickness and cured at ambient temperature about 25° C. for 24 hours to form a dry coating layer of about 2 mil (equivalent to about 0.05 mm) over the test panel.

Coating property data are shown in Tables 4-6. The data indicated that the coating composition of this disclosure had lower VOC, improved gloss at 60°, lower yellowness, improved hardness, faster cure, longer pot life, better adhesion, or a combination thereof.

In Comparative Example 2 (Comp Exp. 2), the coating composition White Color Coat 9P01™ was reduced with organic solvent, n-butyl acetate, without the use of oils. That resulted in higher VOC content at 2.2 lb/gal.

TABLE 4
Coating Properties.

| | Comp Exp. 1 | Comp Exp. 2 | Exp. 1 |
|---|---|---|---|
| Dry to touch (hour) ⁽⁷⁾ | 2 | 2 | 2 |
| Yellowness measured by delta | 1.2 | 0.5 | 0.5 |
| b ⁽⁸⁾ | | | |
| Adhesion ⁽⁹⁾ | 4 | 4 | 5 |
| Persoz hardness (sec) | 40 | 50 | 55 |
| Gloss at 60 degrees | 16 | 17 | 21 |
| VOC (lb/gal) ⁽¹⁰⁾ | 1.8 | 2.2 | 1.8 |

⁽⁷⁾ According to ASTM D-1640.
⁽⁸⁾ Measured on respective dried coating layers using MA-68 color instrument 26, available from X-Rite, Grand Rapids, Michigan, USA.
⁽⁹⁾ According to ASTM D3359.
⁽¹⁰⁾ Volatile organic compounds (VOC) were measured according to ASTM D3960.

TABLE 5
Coating Properties.

| | Comp | Comp | | | |
|---|---|---|---|---|---|
| | Exp. 3 | Exp. 4 | Exp. 2 | Exp. 3 | Exp. 4 |
| Dry to touch (hour) ⁽⁷⁾ | 3 | 4 | 3 | 8 | 2 |
| Yellowness measured by | 0.5 | 1.2 | 0.5 | 0.5 | 0.5 |
| delta b ⁽⁸⁾ | | | | | |
| Pot life (hour) ⁽¹¹⁾ | 1.5 | 0.25 | 0.25 | 1 | 1 |
| Adhesion ⁽⁹⁾ | 4 | 4 | 5 | 5 | 5 |
| Persoz hardness (sec) | 40 | 51 | 60 | 55 | 58 |
| Gloss at 60 degrees | 90 | 89 | 91 | 90 | 92 |
| VOC (lb/gal) ⁽¹⁰⁾ | 2.2 | 1.8 | 1.8 | 1.8 | 1.8 |

⁽⁷⁾-⁽¹⁰⁾: Same as those in Table 4.
⁽¹¹⁾ Pot life can be determined by measuring the length of time required to double viscosity of a coating composition or pot mix. The Zahn cup viscosity measurements can be used. General method can be done according to ISO 9514:2005.

TABLE 6
Coating Properties.

| | Comp | Comp | |
|---|---|---|---|
| | Exp. 5 | Exp. 6 | Exp. 5 |
| Dry to touch (hour) ⁽⁷⁾ | 3 | 2 | 1 |
| Yellowness measured by delta b ⁽⁸⁾ | 1.2 | 0.3 | 0.3 |
| Adhesion ⁽⁹⁾ | 4 | 4 | 5 |
| Persoz hardness (sec) | 29 | 42 | 51 |
| VOC (lb/gal) ⁽¹⁰⁾ | 1.5 | 1.9 | 1.5 |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A coating composition comprising:
a film forming polymer chosen from acrylic polymers, polyester polymers, polyurethane polymers, latex polymers, and a combination thereof; and
a high oleic oil mixed in the film forming polymer, wherein the high oleic oil comprises C18:1 fatty acids in a range of from about 60% to 100% of the fatty acid moieties in the oil and a combination of C18:2 and C18:3 fatty acids in a range of from 0% to about 10% of the fatty acid moieties in the oil, percentage based on the total fatty acid moieties in the high oleic oil, and the high oleic oil has an oxidative stability index in a range of from about 50 hours to about 100 hours at 110° C. measured in the absence of antioxidant.

2. The coating composition of claim 1, wherein the film forming polymers comprises crosslinkable functional group.

3. The coating composition of claim 2, wherein the crosslinkable functional group is chosen from the group comprising a hydroxyl group, an epoxy group, an amine group, a urethane group, and a combination thereof.

4. The coating composition of claim 2 further comprising:
a crosslinking component comprising a crosslinking functional group that reacts with the crosslinkable functional group to form a crosslinked structure.

5. The coating composition of claim 4, wherein the crosslinking functional group is selected chosen from the group comprising an isocyanate group, a melamine group, and a combination thereof.

6. The coating composition of claim 4 further comprising an alkyd cobalt catalyst, a tin catalyst, or a combination thereof.

7. The coating composition of claim 1, wherein the high oleic oil comprises C18:1 fatty acids in a range of from about 80% to 100% of the fatty acid moieties in the high oleic oil and a combination of C18:2 and C18:3 fatty acids in a range of from 0% to about 8% of the fatty acid moieties in the high oleic oil, percentage based on the total fatty acid moieties in the high oleic oil.

8. The coating composition of claim 1, wherein the high oleic oil comprises high oleic oil produced from a genetically modified soybean.

9. The coating composition of claim 1, further comprising an organic solvent, wherein total VOCs (volatile organic compounds) of the coating composition is in a range of from about 0.5 lb/gal to about 1.9 lb/gal.

10. The coating composition of claim 1, further comprising a pigment, wetting agent, leveling and flow control agent, leveling agent based on (meth)acrylic homopolymers, rheological control agent, thickener, antifoaming agent, catalyst, organic solvent, or a combination thereof.

11. The coating composition of claim 1, wherein the film forming polymer comprises a linear polymer, branched polymer, or a combination thereof.

12. The coating composition of claim 1, wherein the coating composition is a primer coating composition, a basecoat coating composition, or a top coat coating composition.

13. The coating composition of claim 1, wherein the coating composition comprises in a range of from about 1% to about 40% of the high oleic oil, percent based on the total weight of the coating composition.

14. The coating composition of claim 1, further comprising a surfactant, emulsifier, or a combination thereof, and wherein the coating composition comprises in a range of from about 20% to about 80% of water, percent based on the total weight of the coating composition.

15. A coated article comprising:
a substrate; and
a coating layer on the substrate, the coating layer formed from a coating composition comprising:
a film forming polymer chosen from acrylic polymers, polyester polymers, polyurethane polymers, latex polymers, and a combination thereof; and
a high oleic oil mixed in the film forming polymer, wherein the high oleic oil comprises C18:1 fatty acids in a range of from about 60% to about 100% of the fatty acid moieties in the oil and a combination of C18:2 and C18:3 fatty acids in a range of from 0% to about 10% of the fatty acid moieties in the oil, percentage based on the total fatty acid moieties in the high oleic oil, and the high oleic oil has an oxidative stability index in a range of from about 50 hours to about 100 hours at 110° C. measured in the absence of antioxidant,
wherein the coating layer has a Persoz hardness of at least about 50 sec.

16. (canceled)

17. The coated article of claim 15, wherein the substrate is a vehicle, a vehicle part, or a combination thereof.

18. A process for forming a dry coating layer over a substrate, the process comprising the steps of:
forming a coating composition comprising a high oleic oil and a film forming polymer selected from an acrylic polymer, a polyester polymer, a polyurethane polymer, a latex polymer, or a combination thereof, wherein the high oleic oil comprises C18:1 fatty acids in a range of from about 60% to 100% of the fatty acid moieties in the high oleic oil and a combination of C18:2 and C18:3 fatty acids in a range of from 0% to about 10% of the fatty acid moieties in the high oleic oil, percentage based on the total fatty acid moieties in the high oleic oil, and the high oleic oil has an oxidative stability index in a range of from about 50 hours to about 100 hours at 110° C. measured in the absence of antioxidant; and
applying the coating composition over the substrate to form a wet coating layer thereon.

19. The process of claim 18, further comprising the step of:
curing the wet coating layer at an ambient temperature in a range of from about 15° C. to about 35° C., at an elevated temperature in a range of from about 35° C. to about 200° C., or a combination thereof, to form the dry coating layer.

20. The process of claim 18, wherein the high oleic oil comprises C 18:1 fatty acids in a range of from about 80% to 100% of the fatty acid moieties in the high oleic oil and a combination of C18:2 and C18:3 fatty acids in a range of from 0% to about 8% of the fatty acid moieties in the high oleic oil, percentage based on the total fatty acid moieties in the high oleic oil.

21. (canceled)

22. The process of claim 18, wherein total VOCs (volatile organic compounds) of the coating composition is in a range of from about 0.5 lb/gal to about 1.9 lb/gal.
